(19) United States
(12) Patent Application Publication
(10) Pub. No.: US 2021/0200810 A1
(43) Pub. Date: Jul. 1, 2021

(54) MANAGEMENT APPARATUS, MATCHING APPARATUS, MATCHING SYSTEM, MANAGEMENT METHOD, MATCHING METHOD, AND STORAGE MEDIUM

(71) Applicant: NEC CORPORATION, Tokyo (JP)

(72) Inventors: Katsuya NAKASHIMA, Tokyo (JP); Akihiro IWANAMI, Tokyo (JP); Koui NORIMATSU, Tokyo (JP); Yusuke ASHIDA, Tokyo (JP)

(73) Assignee: NEC CORPORATION, Tokyo (JP)

(21) Appl. No.: 17/057,870

(22) PCT Filed: May 20, 2019
(86) PCT No.: PCT/JP2019/019945

§ 371 Date: Nov. 23, 2020

(30) Foreign Application Priority Data
May 24, 2018 (JP) 2018-099617

(51) Int. Cl. G06F 16/9035; G06F 16/909

(52) U.S. Cl. CPC G06F 16/9035; G06F 16/909

(57) ABSTRACT

Provided are a management apparatus, a matching system, a management method, a matching method, and a storage medium that can improve matching accuracy when performing matching using passage history information. The management apparatus includes: a passenger information acquisition unit that acquires passenger information related to a passenger; and a management unit that creates matching-use passage history information used for matching based on the passenger information and passage history information related to the passenger.

### TECHNICAL FIELD

The present invention relates to a management apparatus, a matching apparatus, a matching system, a management method, a matching method, and a storage medium.

### BACKGROUND ART

Patent Literature 1 discloses a personal identification system that performs first matching of first biometric information in a passenger information database with biometric information in a biometric information watch list. After the first matching, the personal identification system disclosed in Patent Literature 1 performs second matching of the first biometric information in the passenger information database with second biometric information acquired by a biometric information acquisition function.

Furthermore, when a difference between the time of the first matching and the current time is larger than predetermined period, the personal identification system disclosed in Patent Literature 1 performs third matching of the first biometric information in the user information database with biometric information in a biometric information watch list added on and after the first matching. On the other hand, when the difference is within the predetermined period, the third matching is omitted. Accordingly, the time required for checking biometric information watch list is reduced.

### CITATION LIST

### Patent Literature

PTL 1: Japanese Patent Application Laid-open No. 2012-088944

### SUMMARY OF INVENTION

### Technical Problem

In the personal identification system disclosed in Patent Literature 1, however, only the matching for updated biometric information in a biometric information watch list can be omitted. Thus, in the personal identification system disclosed in Patent Literature 1, it is difficult to improve matching accuracy of biometric information.

In view of the problem described above, the present invention intends to provide a management apparatus, a matching apparatus, a matching system, a management method, a matching method, and a storage medium that can improve matching accuracy when performing matching using passage history information.

### Solution to Problem

According to one example aspect of the present invention, provided is a management apparatus including: a passenger information acquisition unit that acquires passenger information related to a passenger; and a management unit that creates matching-use passage history information used for matching based on the passenger information and passage history information related to the passenger.

According to another example aspect of the present invention, provided is a matching apparatus configured to communicate with a management apparatus, the management apparatus includes a passenger information acquisition unit that acquires passenger information related to a passenger and a management unit that creates matching-use passage history information used for matching based on the passenger information and passage history information related to the passenger, and the matching apparatus includes: a target person information acquisition unit that acquires target person information related to a target person; and a matching unit that matches information included in the target person information with information included in the matching-use passage history information.

According to yet another example aspect of the present invention, provided is a matching system comprising a management apparatus and a matching apparatus configured to communicate with the management apparatus, the management apparatus includes a passenger information acquisition unit that acquires passenger information related to a passenger and a management unit that creates matching-use passage history information used for matching based on the passenger information and passage history information related to the passenger, and the matching apparatus includes a target person information acquisition unit that acquires target person information related to a target person, and a matching unit that matches information included in the target person information with information included in the matching-use passage history information.

According to yet another example aspect of the present invention, provided is a management method including: acquiring passenger information related to a passenger; and creating matching-use passage history information used for matching based on the passenger information and passage history information related to the passenger.

According to yet another example aspect of the present invention, provided is a matching method including: acquiring passenger information related to a passenger; creating matching-use passage history information used for matching based on the passenger information and passage history information related to the passenger; acquiring target person information related to a target person; and matching information included in the target person information with information included in the matching-use passage history information.

According to yet another example aspect of the present invention, provided is a storage medium storing a program that causes a computer to perform: acquiring passenger information related to a passenger; and creating matching-use passage history information used for matching based on the passenger information and passage history information related to the passenger.

### Advantageous Effects of Invention

According to the present invention, it is possible to improve matching accuracy when performing matching using passage history information.

### BRIEF DESCRIPTION OF DRAWINGS

FIG. 1 is a schematic diagram illustrating a general configuration of a matching system according to one example embodiment of the present invention.

FIG. 2 is a block diagram illustrating an example of a hardware configuration of a management server, an information server, and an automated gate in the matching system according to one example embodiment of the present invention.

FIG. 3 is a sequence diagram illustrating the operation of the information server, the management server, and the automated gate in the matching system according to one example embodiment of the present invention.

FIG. 4 is a schematic diagram illustrating an example of a passenger information database of the information server according to one example embodiment of the present invention.

FIG. 5 is a schematic diagram illustrating an example of a passage history information database of the management server according to one example embodiment of the present invention.

FIG. 6 is a schematic diagram illustrating an example of a temporary information database of the management server according to one example embodiment of the present invention.

FIG. 7 is a block diagram illustrating a configuration of a matching system according to another example embodiment of the present invention.

### DESCRIPTION OF EMBODIMENTS

### One Example Embodiment

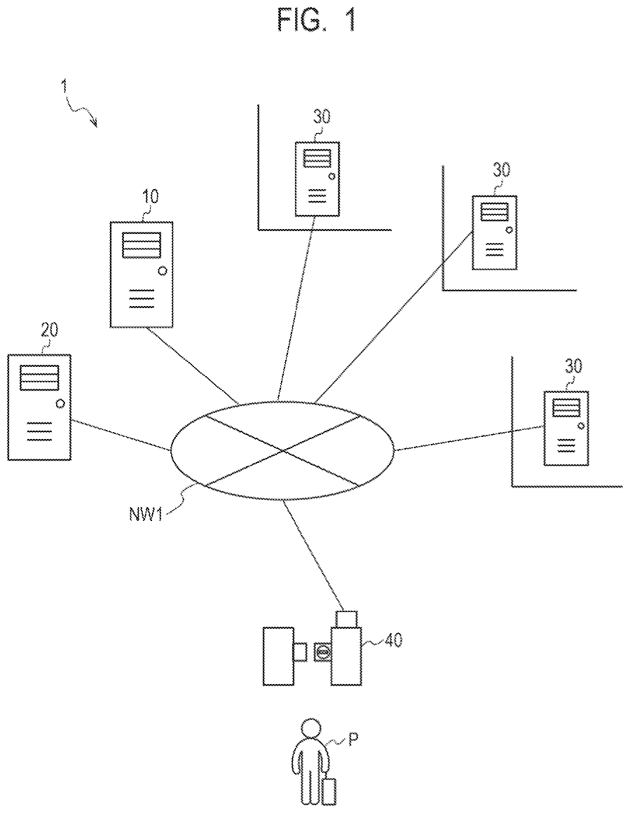

A management apparatus, a matching apparatus, a matching system, a management method, and a matching method according to one example embodiment of the present invention will be described with reference to FIG. 1 to FIG. 6.

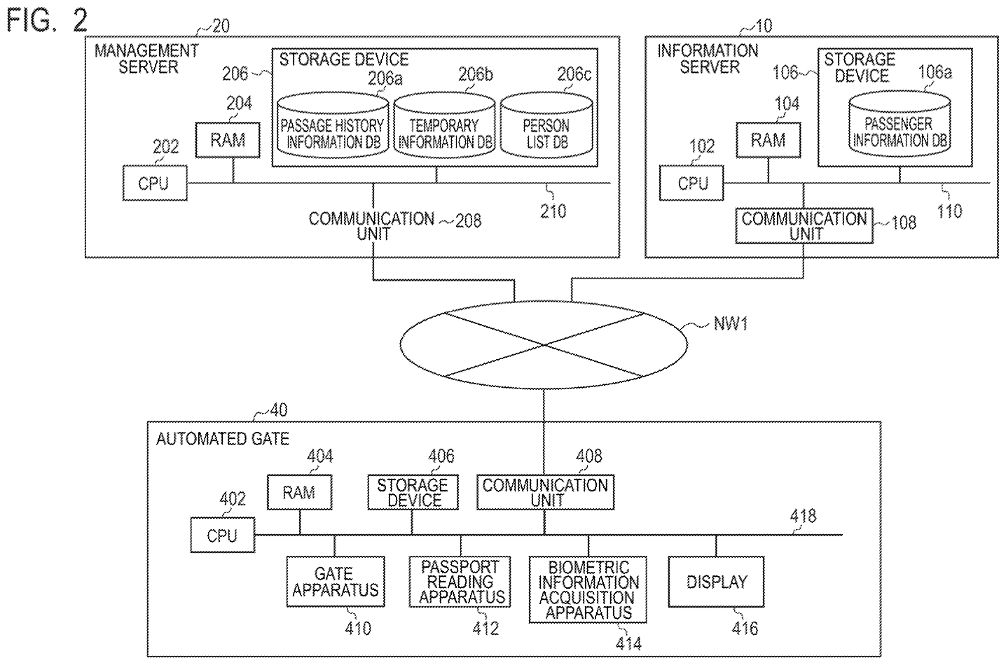

First, the configuration of the matching system according to the present example embodiment will be described with reference to FIG. 1 and FIG. 2. FIG. 1 is a schematic diagram illustrating a general configuration of the matching system according to the present example embodiment. FIG. 2 is a block diagram illustrating an example of a hardware configuration of a management server, an information server, and an automated gate in the matching system according to the present example embodiment.

As illustrated in FIG. 1, a matching system 1 according to the present example embodiment includes an information server 10, a management server 20, company servers 30, and an automated gate 40. The matching system 1 according to the present example embodiment performs matching of biometric information on a passenger P at the automated gate 40 that performs an automatic procedure of entry inspection on the passenger P subjected to entry inspection at an airport of a country in which the matching system 1 is operated, for example. In the following description, a country in which the matching system 1 is operated is simply referred to as “the country of interest” as appropriate.

Note that the matching system 1 may perform matching at the automated gate 40 installed in a facility in which immigration inspection is performed, such as a seaport or a border checkpoint of the country of interest in addition to an airport of the country of interest.

The information server 10 is installed in a facility of an institute or a company that manages and operates the information processing system used for procedures related to arrival and departure of an airplane or the like in the country of interest, for example. The management server 20 is installed in a facility of an administration office that manages departure from and entry to the country of interest, for example. The automated gate 40 is installed in an entry inspection site of an airport of the country of interest. The number of installed automated gates 40 in the entry inspection site is not particularly limited and may be one or plural.

Each company server 30 is a server managed and operated by an airline company that operates an airplane used by the passenger P who makes a passage to the country of interest from a foreign country. Note that the company server 30 may be a server managed and operated by a company that operates passenger transport business to operate a transportation system such as a ship other than airplanes used by the passenger P who makes a passage to the country of interest from a foreign country.

The information server 10, the management server 20, the company servers 30, and the automated gate 40 are connected to a network NW1. The network NW1 is formed of a Wide Area Network (WAN), a Local Area Network (LAN), or the like.

The information server 10 and the management server 20 can communicate with each other via the network NW1. The information server 10 and the company server 30 can communicate with each other via the network NW1. The management server 20 and the automated gate 40 can communicate with each other via the network NW1.

The information server 10 functions as an information management apparatus that manages passenger information, which is information related to the passenger P who makes a passage to the country of interest from a foreign country. The company server 30 transmits and reports the passenger information on the passenger P heading toward the country of interest using an airplane of the airline company to the information server 10 via the network NW1. For example, the company server 30 transmits and reports passenger information to the information server 10 in advance by a predetermined period before departure of an airplane used by the passenger P or at a predetermined point of time before the departure. Further, for example, the company server 30 can transmits passenger information to the information server 10 between the time when passage information is finalized after the passenger P makes check-in and the time when entry inspection in the country of interest for entry is performed, more specifically, between check-in and takeoff of an airplane. Further, for example, the company server 30 may transmit passenger information to the information server 10 between the time when the passenger P makes check-in and the time when the airplane arrives or the passenger P comes to the entry inspection site. The information server 10 registers passenger information transmitted from the company server 30 of each airline company in a passenger information database (DB) 106a and manages the passenger information as described later.

The information server 10 has a central processing unit (CPU) 102, a random access memory (RAM) 104, a storage device 106, and a communication unit 108, as illustrated in FIG. 2. The CPU 102, the RAM 104, the storage device 106, and the communication unit 108 are connected to a bus line 110.

The CPU 102 functions as a control unit that operates by executing a program stored in the storage device 106 and controls the operation of the overall information server 10. Further, the CPU 102 executes an application program stored in the storage device 106 and performs various processes as the information management apparatus. The RAM 104 provides a memory area required for the operation of the CPU 102.

More specifically, the CPU 102 functions as a management unit and stores, in the storage device 106, and manages passenger information reported in advance from the company servers 30 of respective airline companies that operate international flights to the country of interest. The CPU 102 registers passenger information in the passenger information DB 106a stored in the storage device 106 and manages the passenger information. In a foreign country, passengers depart toward the country of interest for various purposes such as tourism, business, return to the country, temporary return, or the like. Such passenger information on various passengers P is acquired at reservation of an airplane, a boarding procedure, or the like in airline companies of respective countries. The company server 30 transmits and reports the acquired passenger information to the information server 10 via the network NW1 in advance as described above. The CPU 102 aggregates and registers passenger information, which is reported in advance from the company servers 30 of airline companies of respective countries, in the passenger information DB 106a of the storage device 206.

Further, the CPU 102 functions as a providing unit and transmits and provides passenger information to the management server 20 via the network NW1. The CPU 102 regularly or irregularly provides passenger information to the management server 20 in advance before entry of the passenger P to the country of interest.

The storage device 106 is formed of a storage medium such as a nonvolatile memory, a hard disk drive, or the like and functions as a storage unit. The storage device 106 stores a program executed by the CPU 102, data referenced by the CPU 102 when executing the program, or the like.

Further, the storage device 106 stores the passenger information DB 106a. The passenger information described above is registered in the passenger information DB 106a.

The passenger information registered in the passenger information DB 106a is information related to the passenger P heading toward the country of interest. For example, the passenger information includes passport information, itinerary information, or the like on the passenger P. The passport information includes a passport number, a passport issuance country, identity information, or the like of a passport issued for the passenger P. The identity information includes the name, the nationality, the date of birth, the sexuality, or the like of the passenger P. The itinerary information is information indicating an itinerary of the passenger P and includes a departure place, an arrival place, an airline company to use, a flight number, a departure date and time, an arrival data and time, or the like of the passenger P. An airline company, a flight number, a departure date and time, and an arrival data and time form flight information. The departure date and time may instead be a departure date not including time. The arrival date and time may instead be an arrival date not including time. The departure place and the arrival place may mean an airport of departure and an airport of destination, respectively. The passenger information and the passport information and the itinerary information included in the passenger information are associated with each other.

The communication unit 108 is connected to the network NW1 and transmits and receives data via the network NW1. The communication unit 108 performs communication between the management server 20, the company servers 30, or the like under the control of the CPU 102.

The information server 10 is configured in such a way.

The management server 20 functions as a management apparatus that stores and manages various information required for immigration inspection operation of the country of interest. As illustrated in FIG. 2, the management server 20 has a CPU 202, a RAM 204, a storage device 206, and a communication unit 208. The CPU 202, the RAM 204, the storage device 206, and the communication unit 208 are connected to a bus line 210.

The CPU 202 functions as a control unit that operates by executing a program stored in the storage device 206 and controls the operation of the overall management server 20. Further, the CPU 202 executes an application program stored in the storage device 206 and performs various processes as the management apparatus. The RAM 204 provides a memory area required for the operation of the CPU 202.

More specifically, the CPU 202 functions as a management unit and records and manages passage history information regarding immigration of the passenger P in the country of interest in the storage device 206. The CPU 202 registers passage history information in the passage history information DB 206a stored in the storage device 206 and manages the passage history information. In the country of interest, foreigners enter the country from various foreign countries for various purposes such as tourism, business, or the like, and the foreigners who have entered the country then depart from the country. Further, in the country of interest, citizens of the country and foreign residents depart from the country for various purposes such as tourism, business, temporary homecoming, or the like, and the citizens of the country and the foreign residents who have departed from the country then enter the country. Such various passage history information on the passenger P is acquired by the face-to-face inspection booth in the entry inspection site, the automated gate 40, or the like and transmitted to the management server 20, for example. The CPU 202 stores and manages the transmitted passage history information in the storage device 206. Note that a foreigner means a person who does not have nationality of the country of interest.

Further, the CPU 202 functions as a passenger information acquisition unit and acquires passenger information provided from the information server 10 via the network NW1.

Further, the CPU 202 functions as a management unit and creates a temporary information DB 206b from the passage history information DB 206a based on passenger information provided and acquired from the information server 10. The CPU 202 refines passage history information in the passage history information DB 206a based on passenger information. Accordingly, compared to the passage history information in the passage history information DB 206a, the CPU 202 creates the temporary information DB 206b in which the refined and reduced number of pieces of passage history information are registered. Details of creation of the temporary information DB 206b will be described later. The CPU 202 stores the created temporary information DB 206b in the storage device 206.

Further, the CPU 202 functions as a management unit and stores and manages, in the storage device 206, a person list including a watch list and a trusted list. The CPU 202 registers and manages a person list in a person list DB 206c stored in the storage device 206. The watch list is a list that registers person information including biometric information on a person under surveillance who requires special attention in immigration inspection or who is to be rejected before immigration. The trusted list is a list that registers person information including biometric information on a person who is to be permitted for entry to the country.

A person list is used for matching at the automated gate 40 or matching at the inspection booth, for example. Note that the person list is not necessarily required to include both the watch list and the trusted list but may include either one of the watch list and the trusted list.

The storage device 206 is formed of a storage medium such as a nonvolatile memory, a hard disk drive, or the like and functions as a storage unit. The storage device 206 stores a program executed by the CPU 202, data referenced by the CPU 202 when executing the program, or the like.

Further, the storage device 206 stores a passage history information DB 206a, a temporary information DB 206b, and a person list DB 206c. The passage history information described above is registered in the passage history information DB 206a. The refined passage history information described above is registered in the temporary information DB 206b. The person list described above is registered in the person list DB 206c.

The passage history information registered in the passage history information DB 206a is information regarding the passenger P having a passage history of entry to the country of interest. For example, the passage history information is registered when the passenger P enters the country of interest and when the passenger P departs from the country of interest. For example, the passage history information includes passport information, biometric information, history information, and the like on the passenger P having a passage history to the country of interest. The passport information includes a passport number, a passport issuance country, identity information, or the like of a passport issued for the passenger P. The identity information includes the name, the nationality, the date of birth, the sexuality, or the like of the passenger P. The biometric information is a fingerprint image, a face image, an iris image, a finger vein image, a palm-print image, a palm vein image, or the like of the passenger P. One or multiple pieces of biometric information may be used. Further, the biometric information may be acquired from integrated circuit (IC) passport in which biometric information on the passenger P is stored or may be acquired directly from the passenger P in inspection. The history information includes an entry country, a date of entry, a departure country, a date of departure, a flight number, or the like on the passenger P. The entry country and the departure country may mean an airport for entry to the country and an airport for departure from the country, respectively. The passage history information and the passport information, biometric information, and history information included in the passage history information are associated with each other.

The passage history information registered in the temporary information DB 206b is passage history information associated with personal identification information of the passenger P included in passenger information which satisfies a particular condition in the passenger information DB 106a out of passage history information registered in the passage history information DB 206a. That is, the passage history information registered in the temporary information DB 206b is passage history information corresponding to passenger information which satisfies the particular condition in the passenger information DB 106a out of passage history information registered in the passage history information DB 206a. The particular condition may be, for example, a condition that the departure date and time or the departure date of the passenger information is included in a predetermined period, a condition that the arrival date and time or the arrival date of the passenger information is included in a predetermined period, the departure place of the passenger information is a particular place of destination, that is, a particular airport or a group of particular airports, or the like. Details of the particular condition will be described later. Further, the personal identification information on the passenger P is not particularly limited and is a passport number, for example. Further, the personal identification information may be, for example, a combination of two or more pieces of identity information such as a name, a nationality, a date of birth, or the like. The passage history information registered in the temporary information DB 206b is matching-use passage history information used for matching of identity verification in entry inspection at the automated gate 40.

The person list registered in the person list DB 206c includes a watch list and a trusted list. In the watch list, biometric information, text information, or the like is registered as person information on a person under surveillance who requires special attention in immigration inspection or who is to be rejected before immigration. Further, in the trusted list, biometric information, text information, or the like is registered as person information on a person who is to be permitted for entry to the country. The biometric information included in each person information of the watch list and the trusted list may be, for example, a fingerprint image, a face image, an iris image, a finger vein image, a palm-print image, a palm vein image, or the like of the person of interest.

The communication unit 208 is connected to the network NW1 and transmits and receives data via the network NW1. The communication unit 208 communicates with the information server 10, the automated gate 40, or the like under the control of the CPU 202.

The management server 20 is configured in such a way.

The automated gate 40 functions as an automatic procedure apparatus that automatically performs a procedure of immigration inspection of the passenger P who is a target person of the automated gate 40 who is allowed to use the automated gate 40. The automated gate 40 functions as a matching apparatus that performs matching of biometric information.

As illustrated in FIG. 2, the automated gate 40 includes a CPU 402, a RAM 404, a storage device 406, a communication unit 408, a gate apparatus 410, a passport reading apparatus 412, a biometric information acquisition apparatus 414, and a display 416. The CPU 402, the RAM 404, the storage device 406, the communication unit 408, the gate apparatus 410, the passport reading apparatus 412, the biometric information acquisition apparatus 414, and the display 416 are connected to a bus line 418.

The CPU 402 functions as a control unit that operates by executing a program stored in the storage device 406 and controls the operation of the overall automated gate 40. Further, the CPU 402 executes an application program stored in the storage device 406 and performs various processes as the automatic procedure apparatus. The RAM 404 provides a memory area required for the operation of the CPU 402.

The storage device 406 is formed of a storage medium such as a nonvolatile memory, a hard disk drive, or the like and functions as a storage unit. The storage device 406 stores a program executed by the CPU 402, data referenced by the CPU 402 when executing the program, or the like.

The communication unit 408 is connected to the network NW1 and transmits and receives data via the network NW1. The communication unit 408 communicates with the management server 20 or the like under the control of the CPU 402.

The gate apparatus 410 transitions from a closed state for standby to block passage of the passenger P to an opened state to permit passage of the passenger P after the passenger P passed through entry inspection at the automated gate 40. The scheme of the gate apparatus 410 is not particularly limited and may be, for example, a flapper gate whose flapper provided on one side of the pathway or flappers provided on both sides of the pathway are opened and closed, a turn style gate whose three bars rotate, or the like.

The passport reading apparatus 412 functions as a passport information acquisition unit that reads a passport of the passenger P and acquires information recorded on the passport in entry inspection at the automated gate 40. The passport reading apparatus 412 functions as one of the target person information acquisition units that acquire target person information that is information related to the passenger P that is a target person who performs a procedure at the automated gate 40. The passport reading apparatus 412 is formed of an optical character reader (OCR) apparatus or a contactless integrated circuit (IC) reader, for example. The passport reading apparatus 412 reads a passport number written on a passport sheet by using an OCR apparatus. Further, in a case of an IC passport, the passport reading apparatus 412 reads a passport number stored in an IC chip of the IC passport by using a contactless IC reader.

Further, in a case of an IC passport, biometric information such as a fingerprint image, a face image, an iris image, a finger vein image, a palm-print image, a palm vein image, or the like of the passenger P at passport application is stored and preregistered in the IC chip thereof. One or multiple pieces of biometric information may be preregistered in an IC chip. Further, multiple pieces of biometric information may be any combination of biometric information. When biometric information is stored in an IC chip, the passport reading apparatus 412 further reads and acquires biometric information stored in an IC chip. The biometric information acquired from an IC passport by the passport reading apparatus 412 is matched with the same type of biometric information acquired by the biometric information acquisition apparatus 414 and used for identity verification of the passenger P.

Note that, in the matching system 1 according to the present example embodiment, it is possible to perform entry inspection by performing matching of biometric information for identity verification without performing reading of a passport by using the passport reading apparatus 412. In such a case, the automated gate 40 functions as a matching apparatus and matches, at 1:N, biometric information acquired by the biometric information acquisition apparatus 414 with the same type of biometric information included in the passage history information on a plurality of persons registered in the temporary information DB 206b of the management server 20. Thereby, the automated gate 40 performs identity verification of the passenger P. A case where identity verification is performed by using the temporary information DB 206b without performing reading of a passport by using the passport reading apparatus 412 in such a way will be described below.

The biometric information acquisition apparatus 414 functions as a biometric information acquisition unit that acquires biometric information on the passenger P that is a target person who performs a procedure at the automated gate 40. The biometric information acquisition apparatus 414 functions as one of the target person information acquisition units that acquire target person information that is information related to the passenger P that is a target person who performs a procedure at the automated gate 40. For example, the biometric information acquisition apparatus 414 acquires biometric information such as a fingerprint image, a face image, an iris image, a finger vein image, a palm-print image, a palm vein image, or the like of the passenger P. One or multiple pieces of biometric information may be acquired by the biometric information acquisition apparatus 414. Further, multiple pieces of biometric information may be any combination of biometric information.

Biometric information to be matched at the automated gate 40, that is, biometric information to be included in the passage history information in the temporary information DB 206b may be automatically set based on the following condition or may be manually changed as appropriate and set by the user such as a manager. For example, biometric information is set in accordance with the specification of the automated gate 40 installed in the airport, specifically, in accordance with whether or not the biometric information acquisition apparatus 414 supports fingerprint authentication using a fingerprint image, supports face authentication using a face image, or the like. Further, for example, when multiple types of biometric information are supported, biometric information is set in accordance with a season such as a busy period of the airport such as the Obon Festival period, the Year-end and New Year holidays including New Year's Day, the Golden Week holidays, or the like, an off-season period of the airport, or the like. Specifically, biometric information is set to a fingerprint image in a busy period, and set to a face image in an off-season period, for example. Further, for example, when multiple types of biometric information are supported, biometric information is set in accordance with the environment of a target departure place, that is, the environment of a target airport. Specifically, biometric information is set to a face image for a case of a passenger who makes a passage from an airport of a safe country or a country having an agreement with the country of interest, and set to a fingerprint image in a case of a passenger who makes a passage from an airport of dangerous countries other than the above, for example.

The display 416 is formed of a touch panel display, for example. The display 416 functions as a display unit and an input unit that displays operation guidance to the passenger P who performs a procedure at the automated gate 40 and accepts entry of an operation instruction from the passenger P.

The automated gate 40 determines, out of passengers P, a particular passenger P as a target person who enters the country of interest and automatically performs an entry inspection procedure of the particular passenger P. In an entry inspection procedure, the CPU 402 of the automated gate 40 functions as a matching unit that matches biometric information.

The particular passenger P that is a target person of the automated gate 40 is not particularly limited and may be, for example, a person for which the number of passages to the country of interest during a predetermined period to the latest entry to the country of interest, more specifically, during a predetermined period before the date of entry to the country of interest is greater than or equal to a predetermined number of times. For example, such a person may be a person who made a passage to the country of interest twice or more within one year on or before the day of entry. Further, the particular passenger P who is a target person of the automated gate 40 may be a person who has a passage history to the country of interest in the past and has no history of being classified into the watch list in the past.

For example, the automated gate 40 automatically performs an entry inspection procedure of the passenger P for which the number of passages to the country of interest during a predetermined period to the latest entry to the country of interest is greater than or equal to a predetermined number of times. At this time, for identity verification, the CPU 402 functioning as a matching unit matches, at 1:N, biometric information on the passenger P acquired by the biometric information acquisition apparatus 414 with the same type of biometric information included in the passage history information on a plurality of persons registered in the temporary information DB 206b of the management server 20.

Further, the CPU 402 that functions as a matching unit may match, at 1:N, biometric information on the passenger P acquired by the biometric information acquisition apparatus 414 with the same type of biometric information on a plurality of persons included in the watch list or the trusted list registered in the person list DB 206c of the management server 20. Accordingly, the CPU 202 can perform watch list matching or trusted list matching with respect to the passenger P.

The automated gate 40 is configured in such a way.

The automated gate 40 automatically performs immigration inspection of the passenger P who is the target person thereof and thus can perform a procedure of immigration inspection smoothly and quickly even when the immigration inspection site is crowded. In general, the automated gate 40 performs identity verification by matching, at 1:1, biometric information registered in advance in an IC passport acquired by the passport reading apparatus 412 with biometric information on the passenger P acquired by the biometric information acquisition apparatus 414. In such a case, however, the passenger P is required to have an IC passport read by the passport reading apparatus 412, which results in a low throughput. In particular, the passenger P often holds much baggage, and it may take time for searching for the IC passport in a situation of having much baggage when causing the passport reading apparatus 412 to read the IC passport. Thus, there is a problem that the passenger P is unable to use the automated gate 40 smoothly if biometric information of the IC passport is used to perform 1:1 matching as described above. Thus, it may be considered to perform 1:N matching of biometric information on the passenger P acquired by the biometric information acquisition apparatus 414 with biometric information included in the passage history information on a plurality of persons registered in the passage history information DB 206a of the management server 20 for identity verification at the automated gate 40.

However, if the biometric information on a plurality of persons in the passage history information DB 206a is used for matching for identity verification of the passenger P, this may result in a numerous number of pieces of biometric information on a plurality of persons of matching targets to be matched with biometric information on the passenger P acquired by the biometric information acquisition apparatus 414. Thus, matching accuracy on the biometric information may be reduced.

In contrast, the matching system 1 according to the present example embodiment creates the temporary information DB 206b by refining the passage history information in the passage history information DB 206a in accordance with a predetermined condition. Furthermore, the matching system 1 matches, at 1:N, biometric information on the passenger P acquired by the biometric information acquisition apparatus 414 with biometric information included in the passage history information on a plurality of persons registered in the temporary information DB 206b for identity verification.

The biometric information on a plurality of persons in the temporary information DB 206b is refined compared to the biometric information on a plurality of persons in the passage history information DB 206a. Thus, in identity verification, it is possible to reduce the number of pieces of biometric information on a plurality of persons of matching targets to be matched to the biometric information on the passenger P acquired by the biometric information acquisition apparatus 414. Therefore, the matching system 1 according to the present example embodiment can improve matching accuracy of biometric information when performing matching with biometric information registered in a database for identity verification of the passenger P. Further, it is possible to reduce the time required for matching of biometric information for identity verification. As described above, the matching system 1 according to the present example embodiment can improve matching accuracy when performing matching using passage history information.

That is, in a case of the passenger P who has a history of one or multiple times of passages in the past, biometric information acquired by the biometric information acquisition apparatus 414 from the passenger P in the past or biometric information acquired by the passport reading apparatus 412 from an IC passport is stored in the passage history information DB 206a. However, if 1:N matching of the biometric information acquired by the biometric information acquisition apparatus 414 in the automated gate 40 with the past biometric information in the passage history information DB 206a that has already been registered is merely performed, this will result in low matching accuracy. This is because of a numerous number of pieces of already registered past biometric information in the passage history information DB 206a corresponding to N.

Accordingly, in the present example embodiment, the already registered past passage history information in the passage history information DB 206a corresponding to N is refined by extraction based on the passenger information on the passenger P to create the temporary information DB 206b. Then, in the present example embodiment, biometric information acquired by the biometric information acquisition apparatus 414 in the automated gate 40 is matched at 1:N with biometric information in the temporary information DB 206b in which the matching-use passage history information refined by the passenger information is registered. Accordingly, in the present example embodiment, since the number N is refined based on the passenger information, it is possible to suppress a reduction of matching accuracy of biometric information and reduce matching time.

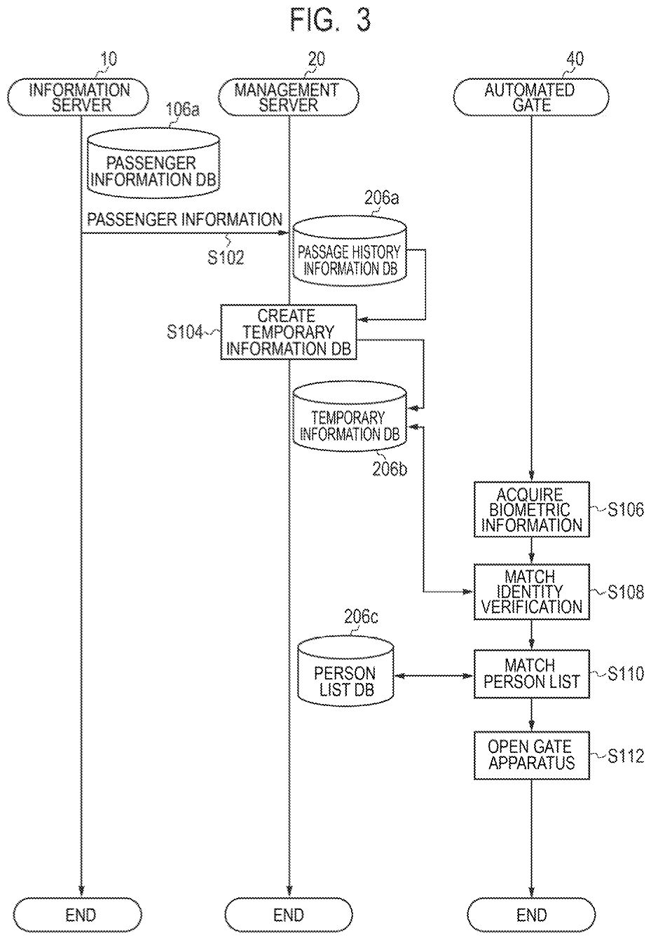

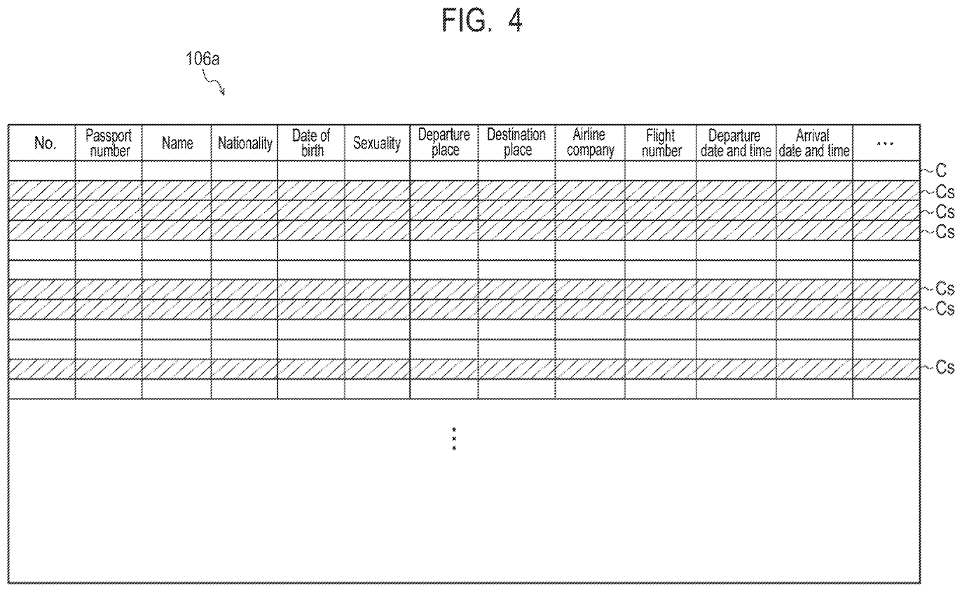

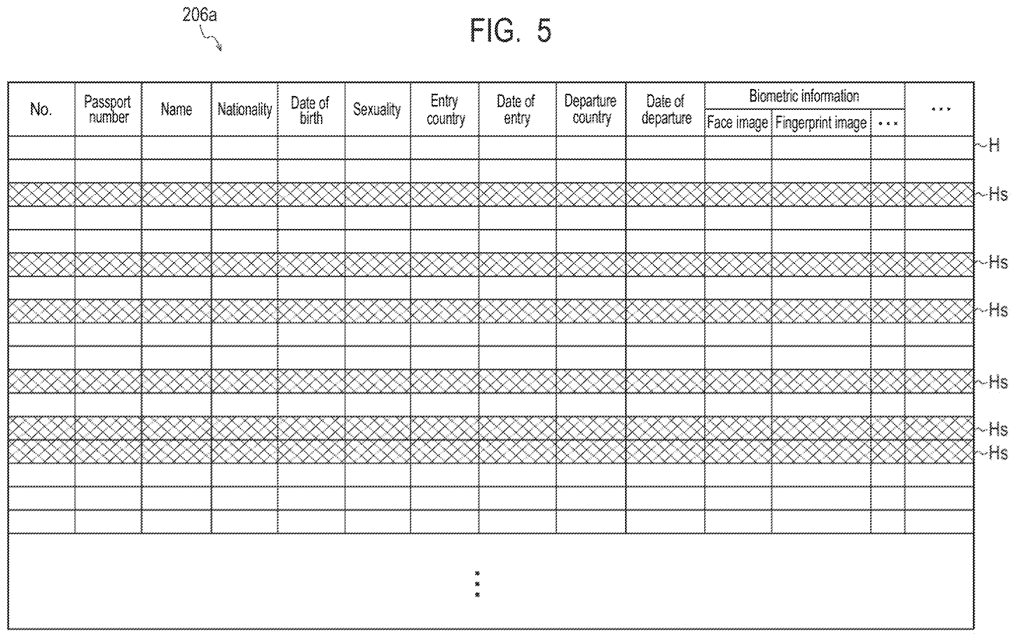

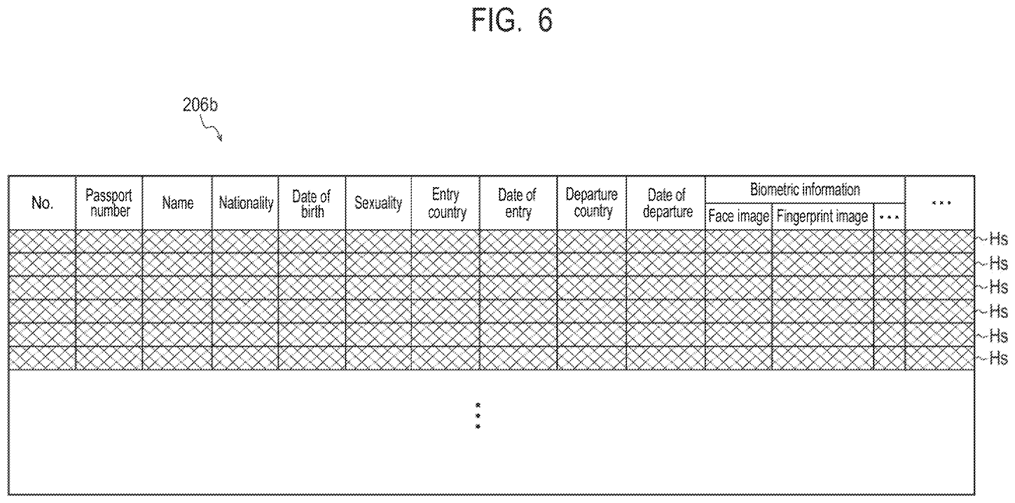

The matching operation in the matching system 1 according to the present example embodiment will be further described below with reference to FIG. 3 to FIG. 6. FIG. 3 is a sequence diagram illustrating the operation of the information server 10, the management server 20, and the automated gate 40 in the matching system according to the present example embodiment. FIG. 4 is a schematic diagram illustrating an example of the passenger information DB 106a of the information server 10 according to the present example embodiment. FIG. 5 is a schematic diagram illustrating an example of the passage history information DB 206a of the management server 20 according to the present example embodiment. FIG. 6 is a schematic diagram illustrating an example of the temporary information DB 206b of the management server 20 according to the present example embodiment. Note that, in each of the DBs 106a, 206a, and 206c illustrated in FIG. 4 to FIG. 6, each item of data is omitted for simplified illustration. When the matching operation in the matching system 1 according to the present example embodiment is performed, the management method and the matching method according to the present example embodiment are performed.

As illustrated in FIG. 3, the CPU 102 of the information server 10 regularly or irregularly transmits and provides passenger information registered in the passenger information DB 106a to the management server 20 via the network NW1 in advance (step S102).

The passenger information is transmitted and reported in advance to the information server 10 from the company server 30 of each airline company for the country of interest via the network NW1. The CPU 102 of the information server 10 aggregates and registers the passenger information, which has been reported in advance, in the passenger information DB 106a of the storage device 206. As illustrated in FIG. 4 as an example, pieces of passenger information C on a plurality of passengers P reported in advance from the company server 30 of each airline company are registered and managed in the passenger information DB 106a. Note that passenger information Cs out of the passenger information C is the passenger information C which satisfies a particular condition described below. The CPU 102 provides the passenger information C of the passenger information DB 106a to the management server 20 in advance.

The CPU 202 of the management server 20 refines passage history information registered in the passage history information DB 206a based on the passenger information provided in advance from the information server 10. That is, the CPU 202 functions as a specifying unit and specifies passenger information including itinerary information satisfying a particular condition. Next, the CPU 202 functions as an extraction unit and extracts passage history information corresponding to the specified passenger information as the matching-use passage history information to refine the passage history information. Thereby, the CPU 202 creates the temporary information DB 206b (step S104). In the temporary information DB 206b, compared to the passage history information in the passage history information DB 206a, refined and reduced number of pieces of passage history information are registered. The CPU 202 can refine the passage history information in the passage history information DB 206a to create the temporary information DB 206b based on passenger information including itinerary information which satisfies a particular condition as described below, for example.

For example, first, out of the passenger information provided in advance from the information server 10, the CPU 202 extracts particular passenger information which satisfies a particular condition, specifically, particular passenger information in which the arrival date and time is included in a predetermined period in which matching for identity verification is performed at the automated gate 40. The arrival date and time may instead be the arrival date. The predetermined period may be, for example, a unit of day or a unit of hour. As illustrated in FIG. 4, the CPU 202 extracts the passenger information Cs which satisfies the particular condition out of the passenger information C in the passenger information DB 106a provided in advance. Further, the CPU 202 may extract particular passenger information based on a departure date and time or a departure date as a reference instead of extracting particular passenger information based on an arrival date and time or an arrival date as a reference.

For example, it is assumed that the arrival date when matching of biometric information for identity verification is performed is April 10. In such a case, passenger information in which the departure date is from April 9 to April 10 including the same date may be extracted as the particular condition in a case of an airport located relatively distant from the departure place. On the other hand, passenger information in which the departure date is the same date, April 10, may be extracted in a case of an airport located relatively close to the departure place. In such a way, it is possible to set a predetermined period including the arrival date in the particular condition on an airport basis taking a time difference into consideration. It is also possible to set a predetermined period including the arrival date in the particular condition evenly without changing the predetermined period on an airport basis.

Further, the particular condition can be changed in accordance with the type of biometric information to be matched for identity verification. For example, when the biometric information to be matched is a fingerprint image, since matching accuracy is high, the predetermined period including the arrival date in the particular condition may be one week, and when the arrival date is April 10, passenger information in which the departure date is from April 3 to April 10 including the same date can be extracted. On the other hand, when the biometric information to be matched is a face image, since matching accuracy is low, the predetermined period including the arrival date in the particular condition may be two days, and when the arrival date is April 10, passenger information in which the departure date is from April 9 to April 10 including the same date can be extracted.

Further, as a scheme for further increasing matching accuracy of biometric information for identity verification, the temporary information DB 206b may be created for each time zone of an arrival date. For example, when the predetermined period including the arrival date in the particular condition is six hours and the arrival date and time is between 12:00 and 18:00 on April 10, passenger information to be extracted can be determined based on the flight time from the departure place for each airport. Specifically, in a case of relatively a distant airport to which the flight time from the departure place is 24 hours, passenger information in which the departure date and time is between 12:00 and 18:00 on April 9 may be extracted. On the other hand, in a case of relatively a close airport to which the flight time from the departure place is 12 hours, passenger information in which the departure date and time is between 0:00 and 6:00 on April 10 may be extracted. In such a way, the passenger information Cs which satisfies a particular condition can be determined based on the length of the predetermined period and the flight time from each airport to the destination airport.

Subsequently, the CPU 202 extracts, from passage history information in the passage history information DB 206a, particular passage history information associated with personal identification information on the passenger P included in the extracted particular passenger information. That is, the CPU 202 extracts particular passage history information corresponding to the extracted particular passenger information from passage history information in the passage history information DB 206a. As illustrated in FIG. 5 as an example, in the passage history information DB 206a, pieces of passage history information H on a plurality of passengers P who made immigration in the past are registered and managed. As illustrated in FIG. 5, the CPU 202 extracts particular passage history information Hs associated with personal identification information on the passenger P included in the particular passenger information Cs out of the passage history information H in the passage history information DB 206a.

Subsequently, the CPU 202 registers the extracted particular passage history information in a database to create the temporary information DB 206b. As illustrated in FIG. 6 as an example, the extracted particular passage history information Hs is registered as the matching-use passage history information in the temporary information DB 206b.

Further, the CPU 202 can use another condition as the following condition as a particular condition to be satisfied by particular passenger information instead of the condition described above or in addition to the condition described above.

For example, first, the CPU 202 extracts particular passenger information which satisfies a particular condition, specifically, particular passenger information including a particular arrival place to be matched for identity verification at the automated gate 40 out of the passenger information provided in advance from the information server 10. The particular arrival place may be a particular airport or may be a group of particular airports. The particular arrival place may also be determined in accordance with a bilateral agreement between an airport in a departure country and an airport in a destination country, a safety aspect, or the like.

Subsequently, the CPU 202 extracts, from passage history information in the passage history information DB 206a, particular passage history information associated with personal identification information on the passenger P included in the extracted particular passenger information in the same manner as the case described above. Subsequently, the CPU 202 registers the extracted particular passage history information in a database to create the temporary information DB 206b.

Note that the CPU 202 may specify passenger information including itinerary information which satisfies various particular conditions in addition to the above and extract passage history information corresponding to the specified passenger information as the matching-use passage history information to create the temporary information DB 206b.

In such a way, the CPU 202 of the management server 20 refines passage history information in the passage history information DB 206a to create the temporary information DB 206b. Note that the CPU 202 updates the temporary information DB 206b as needed. For example, the CPU 202 updates the temporary information DB 206b as a predetermined update interval such as a minute(s), an hour(s), a day(s), or the like elapses. In the update of the temporary information DB 206b, the CPU 202 deletes passenger history information corresponding to passenger information not included in the above predetermined period from the temporary information DB 206b. Further, in the update of the temporary information DB 206b, the CPU 202 adds passenger history information corresponding to passenger information newly included in the above predetermined period to the temporary information DB 206b. That is, the CPU 202 creates matching-use passage history information on a predetermined time interval basis and deletes passage history information not corresponding to particular passenger information which satisfies a particular condition from the temporary information DB 206b on a predetermined time interval basis.

The update interval that the CPU 202 of the management server 20 updates the temporary information DB 206b may be automatically set by the CPU 202 based on the following condition or may be changed as appropriate manually by the user such as a manager.

For example, the CPU 202 can determine and set an update interval by the specification of the automated gate 40 installed in the airport. Specifically, the CPU 202 can determine and set an update interval in accordance with which of iris authentication using an iris image, fingerprint authentication using a fingerprint image, face authentication using a face image, or the like is supported by the biometric information acquisition apparatus 414, for example.

More specifically, in a case of authentication using the three of iris authentication, fingerprint authentication, and face authentication, the CPU 202 may set the update interval to the longest for the case of iris authentication, set the update interval to the second longest for the case of fingerprint authentication, and set the update interval to the shortest for the case of face authentication.

Further, for example, the CPU 202 may determine and set an update interval in accordance with a season such as a busy period of an airport such as the Obon Festival period, the Year-end and New Year holidays including New Year's Day, the Golden Week holidays, or the like, an off-season period, or the like. Specifically, the CPU 202 may set the update interval to be shorter for a busy period of the airport and set the update interval to be longer for an off-season period of the airport.

Further, the CPU 202 may determine and set an update interval in accordance with the environment of a target departure place, that is, the environment of a target airport. Specifically, the CPU 202 may set the update interval to be longer for a case of a passage from an airport of a safe country or a country having an agreement with the country of interest and set the update interval to be shorter for a case of a passage from an airport of dangerous countries other than the above.

In such a way, the CPU 202 can determine and set an update interval of the temporary information DB 206b, that is, an update interval to update the matching-use passage history information in accordance with the situation. The CPU 202 can make determination and setting in accordance with the type of biometric information on the passenger P acquired by the automated gate 40, that is, biometric information on the passenger P included in the matching-use passage history information. Further, the CPU 202 can determine and set an update interval to update the matching-use passage history information in accordance with a season, an environment of the departure place of a passenger, or the like. Note that the manager may determine and manually set an update interval in the same manner in accordance with the above criteria.

Note that matching of biometric information for identity verification at the automated gate 40 may differ in matching accuracy in accordance with the type of biometric information to be matched. Thus, the CPU 202 of the management server 20 can change the refining degree to refine passage history information in the passage history information DB 206a in accordance with the type of biometric information to be matched. That is, the CPU 202 can determine a predetermined period including a departure date and time or an arrival date and time in the particular condition or a particular arrival place in the particular condition in accordance with the type of biometric information. Accordingly, matching accuracy in accordance with the type of biometric information to be matched can be improved.

For example, the matching accuracy is higher in matching of fingerprint images than in matching of face images. Therefore, when matching of fingerprint images is performed for identity verification, the refining degree to refine passage history information in the passage history information DB 206a can be smaller than when matching of face images is performed. That is, the number of pieces of passage history information in the temporary information DB 206b when matching of fingerprint images is performed can be larger than the number of pieces of passage history information in the temporary information DB 206b when matching of face images is performed.

The level of the refining degree can be larger in accordance with the order of matching accuracy of biometric information used for matching for identity verification, for example, in the order of iris images, fingerprint images, and face images. That is, the number of pieces of passage history information in the temporary information DB 206b can be smaller in the order of iris images, fingerprint images, and face images.

Specifically, for example, when matching of fingerprint images is performed, it is possible to extract passage history information associated with personal identification information on the passenger P included in passenger information including an arrival date and time or an arrival date within a predetermined period in a unit of day that is greater than or equal to 24 hours to create the temporary information DB 206b.

On the other hand, for example, when matching of face images is performed, it is possible to extract passage history information associated with personal identification information on the passenger P included in passenger information including an arrival date and time or an arrival date within a predetermined period in a unit of hour that is less than 24 hours to create the temporary information DB 206b. In such a way, it is possible to determine and set the predetermined period to a shorter period when matching of face images is performed than when matching of fingerprint images is performed. Accordingly, passage history information in the temporary information DB 206b can be reduced, and even in a case of face images with relatively low matching accuracy, the matching accuracy of biometric information for identity verification can be improved.

Further, for example, when matching of face images is performed, it is possible to extract passage history information associated with personal identification information on the passenger P included in passenger information including one particular airport as an arrival place to create the temporary information DB 206b. That is, while the target airport is a group of particular airports including a plurality of airports when matching of fingerprint images is performed, one particular airport is an arrival place as the target airport when matching of face images is performed because the matching accuracy is lower than in matching of fingerprint images. Further, passage history information associated with personal identification information on the passenger P included in passenger information including the one particular airport as an arrival place is extracted. In such a way, the number of particular arrival places can be determined and set to be less when matching of face images is performed than when matching of fingerprint images is performed. This can reduce passage history information in the temporary information DB 206b as well, and even in a case of face images with relatively low matching accuracy, the matching accuracy of biometric information for identity verification can be improved.

At the automated gate 40, entry inspection of the passenger P is automatically performed in a predetermined period or airport used in the particular condition by which passage history information is refined as described above. Note that, in the present example embodiment, it is not necessary to cause the passport reading apparatus 412 of the automated gate 40 to read the passport of the passenger P. Furthermore, when biometric information acquired by the biometric information acquisition apparatus 414 is a face image of the passenger P, it is possible to implement walk-through entry inspection that does not require the passenger P to stop at the automated gate 40.

First, in entry inspection, the CPU 402 of the automated gate 40 acquires a fingerprint image, a face image, an iris image, or the like of the passenger P as biometric information on the passenger P by using the biometric information acquisition apparatus 414 (step S106). For example, the CPU 402 may acquire at least one of a fingerprint image and a face image or may acquire any one or a combination of multiple pieces of biometric information including other biometric information.

Next, the CPU 402 matches, at 1:N, biometric information on the passenger P acquired by the biometric information acquisition apparatus 414 with the same type of biometric information included in the passage history information on a plurality of persons registered in the temporary information DB 206b of the management server 20 for identity verification. Thereby, the CPU 402 performs matching for identity verification of the passenger P (step S108).

As a result of the matching, if biometric information matching the biometric information on the passenger P acquired by the biometric information acquisition apparatus 414 is found out of biometric information included in the passage history information on a plurality of persons in the temporary information DB 206b, the CPU 402 determines that identity verification is successful.

In the temporary information DB 206b, compared to the passage history information in the passage history information DB 206a, the refined and reduced number of pieces of passage history information are registered. Therefore, by using biometric information included in passage history information in the temporary information DB 206b as a matching target to be matched with biometric information acquired by the biometric information acquisition apparatus 414, it is possible to improve the matching accuracy of biometric information. Further, it is possible to reduce the time required for matching for identity verification.

Next, the CPU 402 matches, at 1:N, biometric information on the passenger P acquired by the biometric information acquisition apparatus 414 with the same type of biometric information on a plurality of persons included in a watch list or a trusted list registered in the person list DB 206c of the management server 20 (step S110). Accordingly, the CPU 402 performs watch list matching or trusted list matching on the passenger P. Note that the watch list matching or the trusted list matching is targeted to limited persons, the number of persons to be matched is small, a matching rate is faster than that of matching for identity verification, and therefore the throughput is not affected.

In such a way, at the automated gate 40, entry inspection including matching for identity verification, watch list matching, trusted list matching, or the like is performed on the passenger P. Once the passenger P passes through entry inspection, the CPU 402 of the automated gate 40 causes the gate apparatus 410 to transition from a closed state for standby to block passage of the passenger P to an opened state to permit passage of the passenger P (step S112).

As described above, in the present example embodiment, matching of biometric information for identity verification of the passenger P is performed by using biometric information in the temporary information DB 206b created by refining the biometric information on a plurality of persons in the passage history information DB 206a. Therefore, according to the present example embodiment, when matching with biometric information registered in a database for identity verification of the passenger P is performed, the matching accuracy of biometric information can be improved. As described above, according to the present example embodiment, when matching using passage history information is performed, the matching accuracy can be improved.

### Another Example Embodiment

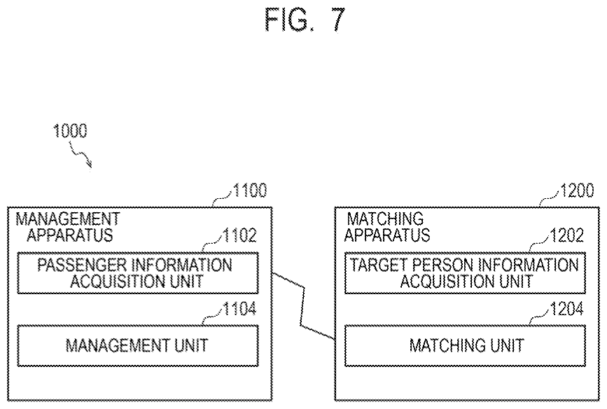

The matching system described in the above example embodiment may be configured as illustrated in FIG. 7 according to another example embodiment. FIG. 7 is a block diagram illustrating a configuration of a matching system according to another example embodiment.

As illustrated in FIG. 7, a matching system 1000 according to another example embodiment includes a management apparatus 1100 and a matching apparatus 1200 capable of communicating with the management apparatus 1100.

The management apparatus 1100 has a passenger information acquisition unit 1102 that acquires passenger information related to a passenger and a management unit 1104 that creates matching-use passage history information used for matching based on the passenger information and passage history information related to the passenger.

The matching apparatus 1200 has a target person information acquisition unit 1202 that acquires target person information related to a target person and a matching unit 1204 that matches information included in the target person information with information included in the matching-use passage history information.

According to another example embodiment, matching-use passage history information used for matching is created based on passenger information and passage history information related to a passenger. Therefore, according to another example embodiment, when matching with biometric information registered in a database is performed, matching accuracy of biometric information can be improved.

### Modified Example Embodiments

The present invention is not limited to the example embodiments described above, and various modifications are possible.

For example, although the case where the information server 10 and the management server 20 are separate servers has been described as an example in the above example embodiments, the example embodiment is not limited thereto. A single server may be configured to function as the information server 10 and the management server 20.

Further, although the case where biometric information included in passage history information in the temporary information DB 206b is used for matching at the automated gate 40 has been described as an example in the above example embodiments, the example embodiment is not limited thereto. For example, biometric information included in passage history information in the temporary information DB 206b may be used for matching of biometric information for identity verification in an inspection booth where face-to-face inspection by an examiner is performed. In such a case, for example, an information terminal installed in a face-to-face inspection booth performs matching of biometric information for identity verification. That is, the information terminal in the face-to-face inspection booth matches biometric information on the passenger P acquired by the biometric information acquisition apparatus installed in the face-to-face inspection booth with biometric information included in passage history information on the temporary information DB 206b in the same manner as in the automated gate 40.

Further, although the case where matching of biometric information is performed by the automated gate 40 at an inspection site where entry inspection is performed has been described as an example in the above example embodiments, the example embodiment is not limited thereto. The matching system according to the present invention can be applied to any cases where biometric information is acquired and used. The matching system according to the present invention can be widely applied to cases where matching of biometric information is performed by an automated gate that automatically inspects whether or not to permit exit or entry at an exit or an entrance of a facility, a site, or the like, for example.

Further, the scope of each of the example embodiments includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the computer program described above is stored but also the computer program itself.

As the storage medium, for example, a floppy (registered trademark) disk, a hard disk, an optical disk, a magneto-optical disk, a compact disk-read only memory (CD-ROM), a magnetic tape, a nonvolatile memory card, or a ROM can be used. Further, the scope of each of the example embodiments includes an example that operates on operating system (OS) to perform a process in cooperation with another software or a function of an add-in board without being limited to an example that performs a process by an individual program stored in the storage medium.

The whole or part of the example embodiments disclosed above can be described as, but not limited to, the following supplementary notes.

(Supplementary Note 1)

A management apparatus comprising:

a passenger information acquisition unit that acquires passenger information related to a passenger; and

a management unit that creates matching-use passage history information used for matching based on the passenger information and passage history information related to the passenger.

(Supplementary Note 2)

The management apparatus according to supplementary note 1, wherein the management unit extracts the matching-use passage history information corresponding to the passenger information from the passage history information based on the passenger information related to the passenger.

(Supplementary Note 3)

The management apparatus according to supplementary note 1 or 2, wherein the passenger information includes itinerary information indicating an itinerary of the passenger,

the management apparatus further comprising a specifying unit that specifies the passenger information including the itinerary information which satisfies a particular condition,

wherein the management unit extracts the passage history information corresponding to the specified passenger information as the matching-use passage history information.

(Supplementary Note 4)

The management apparatus according to supplementary note 1 or 2,

wherein the passenger information includes identification information that identifies the passenger and information related to a departure date and time,

wherein the passage history information includes the identification information, and

wherein from the passage history information, the management unit extracts, as the matching-use passage history information, the passage history information corresponding to the passenger information in which the departure date and time is included in a predetermined period.

(Supplementary Note 5)

The management apparatus according to supplementary note 1 or 2,

wherein the passenger information includes identification information that identifies the passenger and information related to an arrival place,

wherein the passage history information includes the identification information, and

wherein from the passage history information, the management unit extracts, as the matching-use passage history information, the passage history information corresponding to the passenger information in which the arrival place is a particular arrival place.

(Supplementary Note 6)

The management apparatus according to any one of supplementary notes 1 to 5,

wherein the passage history information includes biometric information on the passenger, and

wherein the management unit changes a refining degree to refine the passenger information in accordance with a type of the biometric information.

(Supplementary Note 7)

The management apparatus according to supplementary note 4,

wherein the passage history information includes biometric information on the passenger, and

wherein the management unit determines the predetermined period in accordance with a type of the biometric information.

(Supplementary Note 8)

The management apparatus according to supplementary note 5,

wherein the passage history information includes biometric information on the passenger, and

wherein the management unit determines the particular arrival place in accordance with a type of the biometric information.

(Supplementary Note 9)

The management apparatus according to supplementary note 4,

wherein the passage history information includes biometric information on the passenger, and

wherein the management unit determines the predetermined period to be shorter when the biometric information is a face image than when the biometric information is a fingerprint image.

(Supplementary Note 10)

The management apparatus according to supplementary note 5,

wherein the passage history information includes biometric information on the passenger, and

wherein the management unit determines the number of targeted particular arrival places to be smaller

when the biometric information is a face image than when the biometric information is a fingerprint image.

(Supplementary Note 11)

The management apparatus according to any one of supplementary notes 1 to 10, wherein the management unit creates the matching-use passage history information on a predetermined time interval basis and deletes the passage history information which does not correspond to the passenger information on a predetermined time interval basis.

### (Supplementary Note 12)

The management apparatus according to any one of supplementary notes 1 to 10, wherein the management unit sets an update interval to update the matching-use passage history information in accordance with biometric information acquired by an automated gate, a season, or an environment of a departure place.

(Supplementary Note 13)

The management apparatus according to any one of supplementary notes 1 to 5,

wherein the passage history information includes biometric information on the passenger, and

wherein the biometric information included in the passage history information is matched with biometric information acquired by an automated gate.

(Supplementary Note 14)

A matching apparatus configured to communicate with a management apparatus, wherein the management apparatus includes

a passenger information acquisition unit that acquires passenger information related to a passenger, and

a management unit that creates matching-use passage history information used for matching based on the passenger information and passage history information related to the passenger,

the matching apparatus comprising:

a target person information acquisition unit that acquires target person information related to a target person; and

a matching unit that matches information included in the target person information with information included in the matching-use passage history information.

(Supplementary Note 15)

A matching system comprising a management apparatus and a matching apparatus configured to communicate with the management apparatus,

wherein the management apparatus includes

a passenger information acquisition unit that acquires passenger information related to a passenger, and

a management unit that creates matching-use passage history information used for matching based on the passenger information and passage history information related to the passenger, and

wherein the matching apparatus includes

a target person information acquisition unit that acquires target person information related to a target person, and

a matching unit that matches information included in the target person information with information included in the matching-use passage history information.

(Supplementary Note 16)

A management method comprising:

acquiring passenger information related to a passenger; and

creating matching-use passage history information used for matching based on the passenger information and passage history information related to the passenger.

(Supplementary Note 17)

A matching method comprising:

acquiring passenger information related to a passenger;

creating matching-use passage history information used for matching based on the passenger information and passage history information related to the passenger;

acquiring target person information related to a target person; and

matching information included in the target person information with information included in the matching-use passage history information.

(Supplementary Note 18)

A storage medium storing a program that causes a computer to perform:

acquiring passenger information related to a passenger; and

creating matching-use passage history information used for matching based on the passenger information and passage history information related to the passenger.

As described above, while the present invention has been described with reference to the example embodiments, the present invention is not limited to these example embodiments described above. Various modifications that can be understood by those skilled in the art can be made to the configuration and details of the present invention within the scope of the present invention.

This application is based upon and claims the benefit of priority from Japanese Patent Application No. 2018-099617, filed on May 24, 2018, the disclosure of which is incorporated herein in its entirety by reference.

### REFERENCE SIGNS LIST

1 matching system

10 information server

20 management server

30 company server

40 automated gate

NW1 network

1. A management apparatus comprising:
a passenger information acquisition unit that acquires passenger information related to a passenger; and
a management unit that creates matching-use passage history information used for matching based on the passenger information and passage history information related to the passenger.

2. The management apparatus according to claim 1, wherein the management unit extracts the matching-use passage history information corresponding to the passenger information from the passage history information based on the passenger information related to the passenger.

3. The management apparatus according to claim 1, wherein the passenger information includes itinerary information indicating an itinerary of the passenger,
the management apparatus further comprising a specifying unit that specifies the passenger information including the itinerary information which satisfies a particular condition,
wherein the management unit extracts the passage history information corresponding to the specified passenger information as the matching-use passage history information.

4. The management apparatus according to claim 1, p1 wherein the passenger information includes identification information that identifies the passenger and information related to a departure date and time,
wherein the passage history information includes the identification information, and
wherein from the passage history information, the management unit extracts, as the matching-use passage history information, the passage history information corresponding to the passenger information in which the departure date and time is included in a predetermined period.

5. The management apparatus according to claim 1,
wherein the passenger information includes identification information that identifies the passenger and information related to an arrival place,
wherein the passage history information includes the identification information, and
wherein from the passage history information, the management unit extracts, as the matching-use passage history information, the passage history information corresponding to the passenger information in which the arrival place is a particular arrival place.

6. The management apparatus according to claim 1,
wherein the passage history information includes biometric information on the passenger, and
wherein the management unit changes a refining degree to refine the passenger information in accordance with a type of the biometric information.

7. The management apparatus according to claim 4,
wherein the passage history information includes biometric information on the passenger, and
wherein the management unit determines the predetermined period in accordance with a type of the biometric information.

8. The management apparatus according to claim 5,
wherein the passage history information includes biometric information on the passenger, and
wherein the management unit determines the particular arrival place in accordance with a type of the biometric information.

9. The management apparatus according to claim 4,
wherein the passage history information includes biometric information on the passenger, and
wherein the management unit determines the predetermined period to be shorter when the biometric information is a face image than when the biometric information is a fingerprint image.

10. The management apparatus according to claim 5,
wherein the passage history information includes biometric information on the passenger, and
wherein the management unit determines the number of targeted particular arrival places to be smaller when the biometric information is a face image than when the biometric information is a fingerprint image.

11. The management apparatus according to claim 1, wherein the management unit creates the matching-use passage history information on a predetermined time interval basis and deletes the passage history information which does not correspond to the passenger information on a predetermined time interval basis.

12. The management apparatus according to claim 1, wherein the management unit sets an update interval to update the matching-use passage history information in accordance with biometric information acquired by an automated gate, a season, or an environment of a departure place.

13. The management apparatus according to claim 1,
wherein the passage history information includes biometric information on the passenger, and
wherein the biometric information included in the passage history information is matched with biometric information acquired by an automated gate.

14. A matching apparatus configured to communicate with a management apparatus, wherein the management apparatus includes
a passenger information acquisition unit that acquires passenger information related to a passenger, and
a management unit that creates matching-use passage history information used for matching based on the passenger information and passage history information related to the passenger,
the matching apparatus comprising:
a target person information acquisition unit that acquires target person information related to a target person; and
a matching unit that matches information included in the target person information with information included in the matching-use passage history information.

15. A matching system comprising a management apparatus and a matching apparatus configured to communicate with the management apparatus,
wherein the management apparatus includes
a passenger information acquisition unit that acquires passenger information related to a passenger, and
a management unit that creates matching-use passage history information used for matching based on the passenger information and passage history information related to the passenger, and
wherein the matching apparatus includes
a target person information acquisition unit that acquires target person information related to a target person, and
a matching unit that matches information included in the target person information with information included in the matching-use passage history information.

16. A management method comprising:
acquiring passenger information related to a passenger; and
creating matching-use passage history information used for matching based on the passenger information and passage history information related to the passenger.

17. A matching method comprising:
acquiring passenger information related to a passenger;
creating matching-use passage history information used for matching based on the passenger information and passage history information related to the passenger;
acquiring target person information related to a target person; and
matching information included in the target person information with information included in the matching-use passage history information.

18. A non-transitory storage medium storing a program that causes a computer to perform:
acquiring passenger information related to a passenger; and
creating matching-use passage history information used for matching based on the passenger information and passage history information related to the passenger.
